(19) United States
(12) Patent Application Publication
(10) Pub. No.: US 2011/0206327 A1
(43) Pub. Date: Aug. 25, 2011

(54) ACTIVE OPTICAL CABLE ELECTRICAL CONNECTOR WITH BI-DIRECTIONAL OPTICAL SUB-ASSEMBLY

(75) Inventor: WEI-WEN CHEN, HSINCHU CITY (TW)

(73) Assignee: Jian-Guang Chen, Hsin Chu (TW)

(21) Appl. No.: 12/712,519

(22) Filed: Feb. 25, 2010

(51) Int. Cl. G02B 6/36

(52) U.S. Cl. 385/88

(57) ABSTRACT

An active optical cable electrical connector with bi-directional optical sub-assembly, including: a circuit board having a front end serving as an electrical connector; an optical cable having an internal optical fiber for transmitting and receiving optical signals; and a bi-directional optical sub-assembly electrically connected to the circuit board and connected with a terminal of the optical fiber. The bi-directional optical sub-assembly serves to convert electrical signals received by the electrical connector into optical signals, which are then transmitted through the optical fiber. The bi-directional optical sub-assembly also serves to convert optical signals transmitted from the optical fiber into electrical signals, which are then transmitted through the electrical connector.

### FIELD OF THE INVENTION

The present invention relates generally to a connector applied to an optical system, and more particularly to an active optical cable electrical connector with bi-directional optical sub-assembly.

### BACKGROUND OF THE INVENTION

The conventional active optical cables (AOC) are divided into the following two types: (1) electrical-to-electrical cable 100 as shown in FIG. 1A, and (2) electrical-to-optical cable 110 as shown in FIG. 1B. The electrical-to-electrical cable 100 has two electrical connectors 101 at both ends. The electrical-to-optical cable 110 has an electrical connector 101 at one end and a dual-fiber optical transceiver connector 111 at the other end for receiving/transmitting optical signals.

Please refer to FIGS. 2A and 2B. Either of the above two types of electrical connectors 101 has two optical sub-assemblies (OSA), that is, a transmitter optical sub-assembly (TOSA) 203 and a receiver optical sub-assembly (ROSA) 204. The TOSA 203 is provided with leads. The electrical signals received by the leads are converted into optical signals, which are transmitted via a transmission sleeve 207 through transmission optical fiber 205. The ROSA 204 is provided with leads. The optical signals received by receiving optical fiber 206 is transmitted via a receiving sleeve 208 to the leads and converted into electrical signals. The electrical signals are then transmitted through the leads.

As shown in FIG. 2B, in general, the electrical plug 101 of the active optical cable includes a case 201, an electrical connector 202, a TOSA 203, an ROSA 204, a transmission optical fiber 205, a receiving optical fiber 206, a transmission sleeve 207, a receiving sleeve 208, a cable 209 and an integrated circuit 210.

The above electrical plug 101 of the active optical cable has some defects as follows: First, the electrical plug 101 can only one-way transmit (or receive) the optical signals. Second, the electrical plug 101 must include a case, a circuit board, a TOSA, an ROSA, a transmission optical fiber, a receiving optical fiber, a transmission sleeve, a receiving sleeve, a cable, and an integrated circuit. As a result, the manufacturing process of the electrical plug 101 is complicated to lower the production efficiency thereof.

### SUMMARY OF THE INVENTION

A primary object of the present invention is to simplify the structure of the active optical cable electrical connector and greatly lower manufacturing cost thereof.

To achieve the above and other objects, the active optical cable electrical connector with bi-directional optical sub-assembly (BOSA) of the present invention includes a circuit board having one end serving as an electrical connector, a bi-directional optical sub-assembly, and an optical cable.

With the characteristic of single-fiber bi-directional transmission of the present invention, the structure of the active optical cable electrical connector is simplified to reduce the numbers of the necessary optical sub-assemblies, the sleeves and the optical fibers. Accordingly, the manufacturing process is simplified and the production efficiency is increased so as to lower the manufacturing cost.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein:

FIG. 1A is a view of a conventional electrical-to-electrical cable;

FIG. 1B is a view of a conventional electrical-to-optical cable;

FIG. 2A is a perspective view of an electrical connector of a conventional active optical cable;

FIG. 2B is a perspective view of the electrical connector of the conventional active optical cable, in which an upper cover is removed;

FIG. 3 is a perspective view of the active optical cable electrical connector with bi-directional optical sub-assembly of the present invention;

FIG. 4 is a perspective view of the active optical cable electrical connector with bi-directional optical sub-assembly of the present invention, in which an upper cover is removed;

FIG. 5 is a perspective view of the bi-directional optical sub-assembly of the present invention; and

FIG. 6 is a sectional view of the bi-directional optical sub-assembly of the present invention.

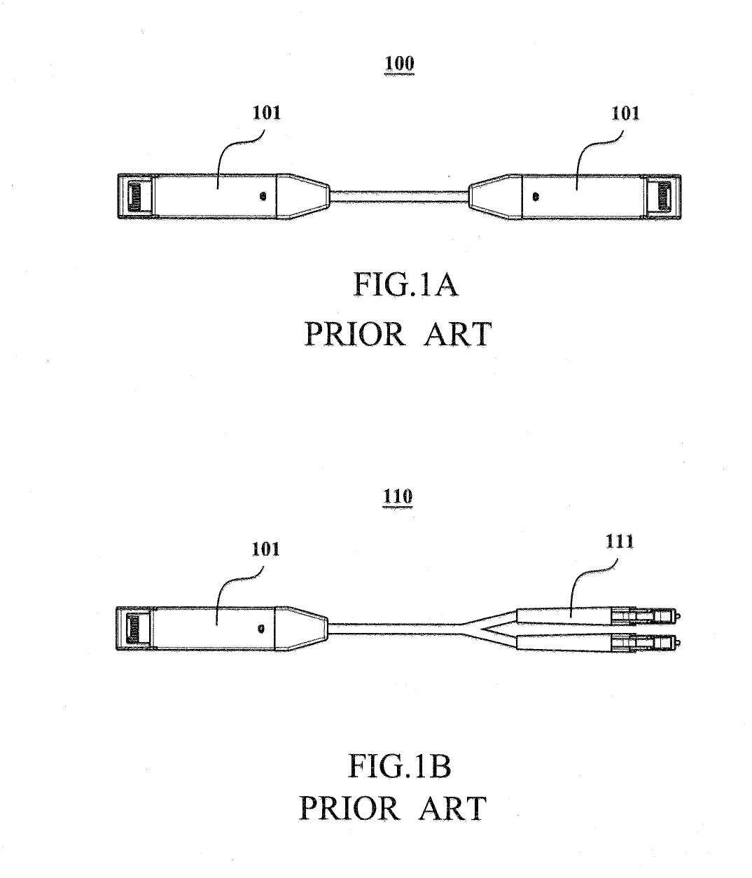

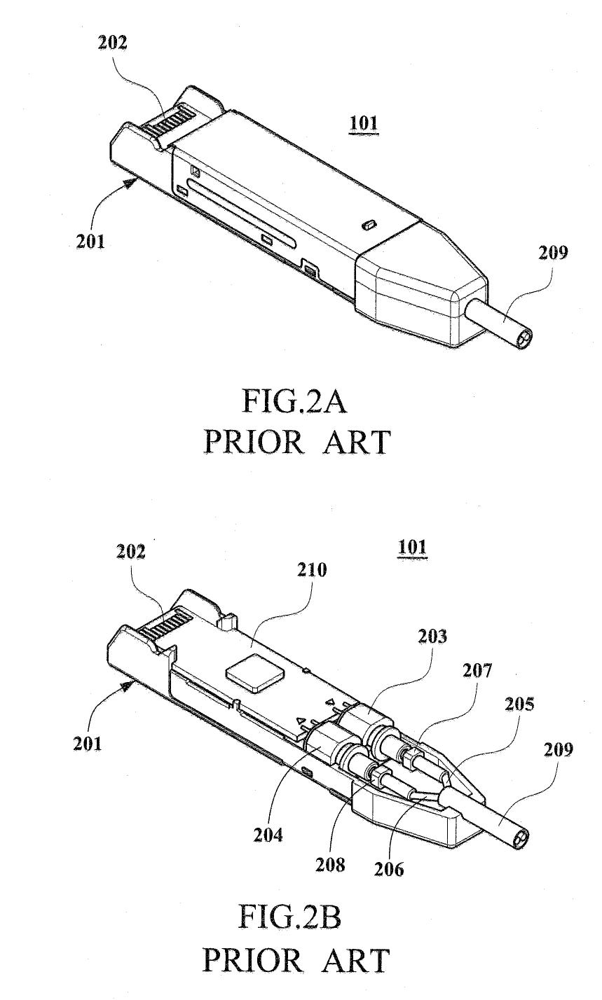

### DETAILED DESCRIPTION OF THE PREFERRED EMBODIMENT

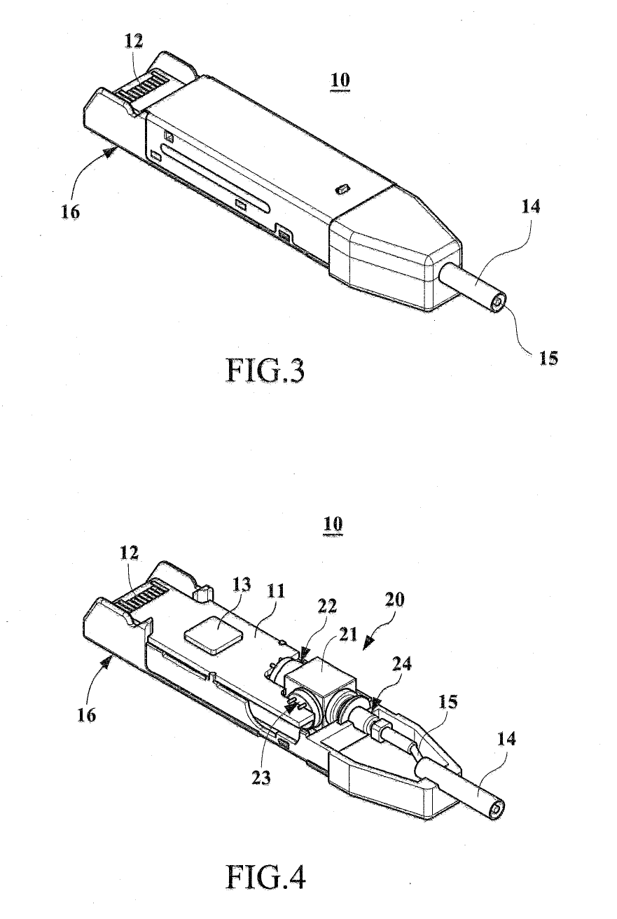

Please refer to FIGS. 3 and 4. The active optical cable electrical connector 10 with bi-directional optical sub-assembly (BOSA) of the present invention includes a circuit board 11 having a slot connector at its front end as an electrical connector 12. The electrical connector 12 can be an XFP electrical connector, an SFP electrical connector, an SFP+ electrical connector or other plug-in electrical connector. An integrated circuit 13 is laid on the circuit board 11. The active optical cable electrical connector 10 further includes a bi-directional optical sub-assembly 20 electrically connected to the circuit board 11, an optical cable 14 having an internal optical fiber 15 for simultaneously transmitting and receiving optical signals, and a case 16 for accommodating the circuit board 11, the bi-directional optical sub-assembly 20 and the optical cable 14.

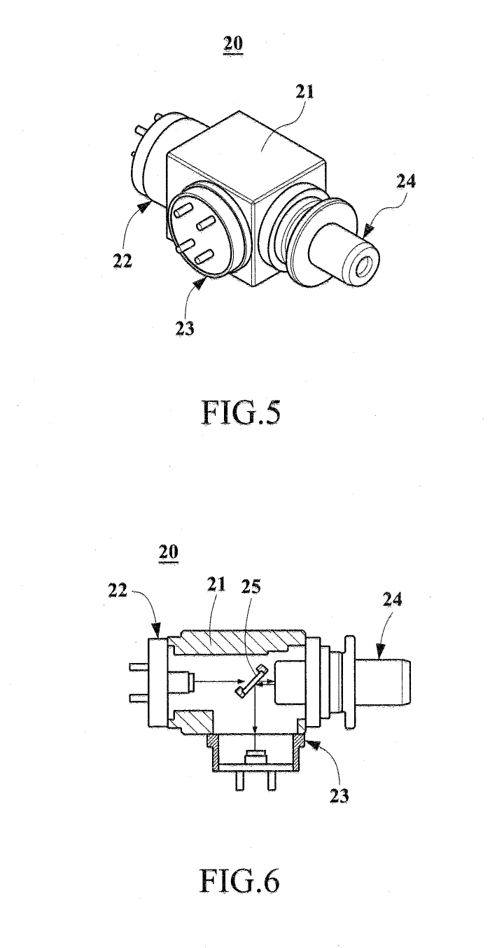

Referring to FIGS. 5 and 6, the bi-directional optical sub-assembly 20 includes a main body 21 on which a light-emitting element 22, a photosensitive element 23 and a sleeve 24 are disposed. A terminal of the optical fiber 15 of the optical cable 14 is connected with the sleeve 24. A beam splitter 25 is positioned in the focus of the light-emitting element 22 and the photosensitive element 23. Media of different transmissivities are evaporated on upper and lower surfaces of the beam splitter 25. Accordingly, the signals transmitted from the light-emitting element 22 are transmitted through the beam splitter 25 and coupled to the optical fiber 15 of the optical cable 14 via the sleeve 24. In the meantime, the signals transmitted from the optical fiber 15 are totally reflected to the photosensitive element 23 via the beam splitter 25.

According to the above arrangement, the bi-directional optical sub-assembly 20 is able to convert electrical signals received by the electrical connector 12 into optical signals. The optical signals are then transmitted through the sleeve 24 to the optical fiber 15 of the optical cable 14 for transmitting the optical signals. Also, by means of the bi-directional optical sub-assembly 20, the optical signals transmitted from the optical fiber 15 of the optical cable 14 via the sleeve 24 are converted into electrical signals. The electrical signals are then transmitted through the electrical connector 12.

In conclusion, with the characteristic of single-fiber bi-directional transmission of the bi-directional optical sub-assembly of the present invention, the structure of the active optical cable electrical connector is simplified to reduce the numbers of the optical sub-assemblies, the sleeves and the optical fibers. Accordingly, the manufacturing process is simplified and the production efficiency is increased so as to lower the manufacturing cost.

The above embodiment is only used to illustrate the present invention, not intended to limit the scope thereof. It is understood that many changes or modifications of the above embodiment can be made by those who are skilled in this field without departing from the spirit of the present invention. The scope of the present invention is limited only by the appended claims.

What is claimed is:

1. An active optical cable electrical connector with bi-directional optical sub-assembly, comprising:
a circuit board having a front end serving as an electrical connector;
an optical cable having an internal optical fiber for transmitting and receiving optical signals; and
a bi-directional optical sub-assembly electrically connected to the circuit board and connected with a terminal of the optical fiber, the bi-directional optical sub-assembly serving to convert electrical signals received by the electrical connector into optical signals, which are then transmitted through the optical fiber, the bi-directional optical sub-assembly also serving to convert optical signals transmitted from the optical fiber into electrical signals, which are then transmitted through the electrical connector.

2. The active optical cable electrical connector with bi-directional optical sub-assembly as claimed in claim 1, wherein the circuit board, the optical cable and the bi-directional optical sub-assembly are accommodated in a case.

3. The active optical cable electrical connector with bi-directional optical sub-assembly as claimed in claim 1, wherein the bi-directional optical sub-assembly includes a main body, a light-emitting element, a photosensitive element and a sleeve being disposed on the main body, the terminal of the optical fiber of the optical cable being connected with the sleeve.

4. The active optical cable electrical connector with bi-directional optical sub-assembly as claimed in claim 3, wherein a beam splitter is positioned in the focus of the light-emitting element and the photosensitive element, whereby the signals transmitted from the light-emitting element are coupled to the optical fiber of the optical cable via the sleeve, while the signals transmitted from the optical fiber are totally reflected to the photosensitive element via the beam splitter.
